(19) United States
(12) Patent Application Publication
(10) Pub. No.: US 2019/0327296 A1
(43) Pub. Date: Oct. 24, 2019

(54) INFORMATION PROCESSING APPARATUS AND NON-TRANSITORY COMPUTER READABLE MEDIUM STORING INFORMATION PROCESSING PROGRAM

(71) Applicant: FUJI XEROX CO., LTD., Tokyo (JP)

(72) Inventor: Naoki HAYASHI, Kanagawa (JP)

(73) Assignee: FUJI XEROX CO., LTD., TOKYO (JP)

(21) Appl. No.: 16/355,825

(22) Filed: Mar. 17, 2019

(30) Foreign Application Priority Data
Apr. 20, 2018 (JP) 2018-081033

(51) Int. Cl. H04L 29/08; H04L 12/58

(52) U.S. Cl. CPC H04L 67/1046; H04L 51/04

(57) ABSTRACT

An information processing apparatus includes a disclosure unit that discloses information regarding a member candidate who wants to subscribe to a group of plural of persons as a new member, to existing members, an acceptance unit that accepts authorizable authority for the member candidate from the existing members viewing the disclosed information, and a determination unit that determines authority to be assigned to the member candidate according to the authorizable authority, in which the authority determined by the determination unit indicates authority of an operation in the group.

### CROSS-REFERENCE TO RELATED APPLICATIONS

This application is based on and claims priority under 35 USC 119 from Japanese Patent Application No. 2018-081033 filed Apr. 20, 2018.

### BACKGROUND

### (i) Technical Field

The present invention relates to an information processing apparatus and a non-transitory computer readable medium storing an information processing program.

### (ii) Related Art

JP4955181B discloses a method of managing a telespace for exchanging delta messages in a plurality of collaborator devices having local data copies, each message having a header and data for updating the local data copies, the method including (a) causing a collaborator device creating the telespace to receive selection of a level of security for determining whether or not authenticity, integrity, and confidentiality of the delta messages are to be protected; (b) causing a collaborator device transmitting the delta messages to add a message authentication code generated by using a predefined MAC algorithm to the messages on the basis of an authentication key, and the header and the data included in the messages, in a case where the level of security selected in step (a) requires protecting the authenticity and integrity of the delta messages; and (c) causing the collaborator device transmitting the delta messages to encrypt the data according to a predefined encryption algorithm by using an encryption key which is different from the authentication key in a case where the level of security selected in step (a) requires protecting the confidentiality of the delta messages, in which the telespace has sub-groups including any collaborator devices among the plurality of collaborator devices, and the encryption key and the authentication key which are individual for each sub-group are used for delta messages transmitted in the sub-groups.

JP4971210B discloses a system in which communication terminals (user terminals) of a plurality of users are configured with server computers which are connectable via a communication network, and which provides a virtual community service in which messages such as text and/or images can be exchanged in a group to which a plurality of users belong as members, on a web site, the system including a user information storage unit that stores user information including identification information assigned to a user registered in the service, identification information of a group to which the user belongs, and an electronic mail address of a user terminal; a group information storage unit that stores identification information and nicknames of all users belonging to a group in correlation with group identification information; a member invitation acceptance unit that acquires user information and group identification information of another user (invitee user) who is desired to participate in a group from a user terminal of a user (inviter user) belonging to the group, and accepts an invitation of a new member; an invitation notification delivery unit that specifies all members belonging to the target group from the user information storage unit and the group information storage unit on the basis of the group identification information, generates an invitation mail including nicknames of the inviter user and the invitee user, and delivers the mail to mail addresses of members other than the inviter user; an invitation mail transmission unit that transmits a mail for invitation to the group to a mail address of the invitee user in a case where approvals for participation of the invitee user in the group are received from all of the members belonging to the group; and a group information update unit that stores the invitee user in the group information storage unit as a member of the group in a case where a desire to participate in the group is received from the invitee user having received the invitation mail.

### SUMMARY

A group including a plurality of persons is formed on a computer for the purpose of communication or the like. In a case where there is a new participant who participates in the group in the middle, and the past information in the group is not disclosed, the new participant may not understand a story thereof. On the other hand, in a case where all pieces of past information are disclosed to a new participant, and the identity of the new participant is not estimated, there is a security risk.

Aspects of non-limiting embodiments of the present disclosure relate to an information processing apparatus and a non-transitory computer readable medium storing an information processing program enabling an existing member to know information regarding a member candidate who wishes to subscribe, and to determine an authorization level for the member candidate.

Aspects of certain non-limiting embodiments of the present disclosure overcome the above disadvantages and other disadvantages not described above. However, aspects of the non-limiting embodiments are not required to overcome the disadvantages described above, and aspects of the non-limiting embodiments of the present disclosure may not overcome any of the problems described above.

According to an aspect of the present disclosure, there is provided an information processing apparatus including a disclosure unit that discloses information regarding a member candidate who wants to subscribe to a group of a plurality of persons as a new member, to existing members; an acceptance unit that accepts authorizable authority for the member candidate from the existing members viewing the disclosed information; and a determination unit that determines authority to be assigned to the member candidate according to the authorizable authority, in which the authority determined by the determination unit indicates authority of an operation in the group.

### BRIEF DESCRIPTION OF THE DRAWINGS

Exemplary embodiment(s) of the present invention will be described in detail based on the following figures, wherein:

FIG. 1 is a conceptual module configuration diagram for a configuration example of a first exemplary embodiment;

FIG. 2 is a diagram illustrating a system configuration example according to the present exemplary embodiment;

FIG. 3 is a flowchart illustrating a process example according to the first exemplary embodiment;

FIG. 4 is a diagram illustrating a data structure example of a user information table;

FIG. 5 is a diagram illustrating a presentation example of a new member candidate information checking screen;

FIG. 6 is a diagram illustrating a presentation example of an authorization level vote screen;

FIG. 7 is a diagram illustrating a presentation example of an authorization level vote screen;

FIG. 8 is a diagram illustrating a data structure example of a vote result table;

FIG. 9 is a conceptual module configuration diagram for a configuration example of a second exemplary embodiment;

FIG. 10 is a flowchart illustrating a process example according to the second exemplary embodiment;

FIG. 11 is a diagram illustrating a process example according to the second exemplary embodiment;

FIG. 12 is a diagram illustrating a process example according to the second exemplary embodiment;

FIG. 13 is a diagram illustrating a process example according to the second exemplary embodiment;

FIG. 14 is a diagram illustrating a process example according to the second exemplary embodiment;

FIG. 15 is a diagram illustrating a process example according to the second exemplary embodiment;

FIG. 16 is a diagram illustrating a process example according to the second exemplary embodiment;

FIG. 17 is a diagram illustrating a process example according to the second exemplary embodiment;

FIG. 18 is a diagram illustrating a process example according to the second exemplary embodiment;

FIG. 19 is a diagram illustrating a process example according to the second exemplary embodiment; and

FIG. 20 is a block diagram illustrating a hardware configuration example of a computer realizing the present exemplary embodiment.

### DETAILED DESCRIPTION

Hereinafter, with reference to the drawings, a description will be made of various exemplary embodiments for realizing the invention.

### First Exemplary Embodiment

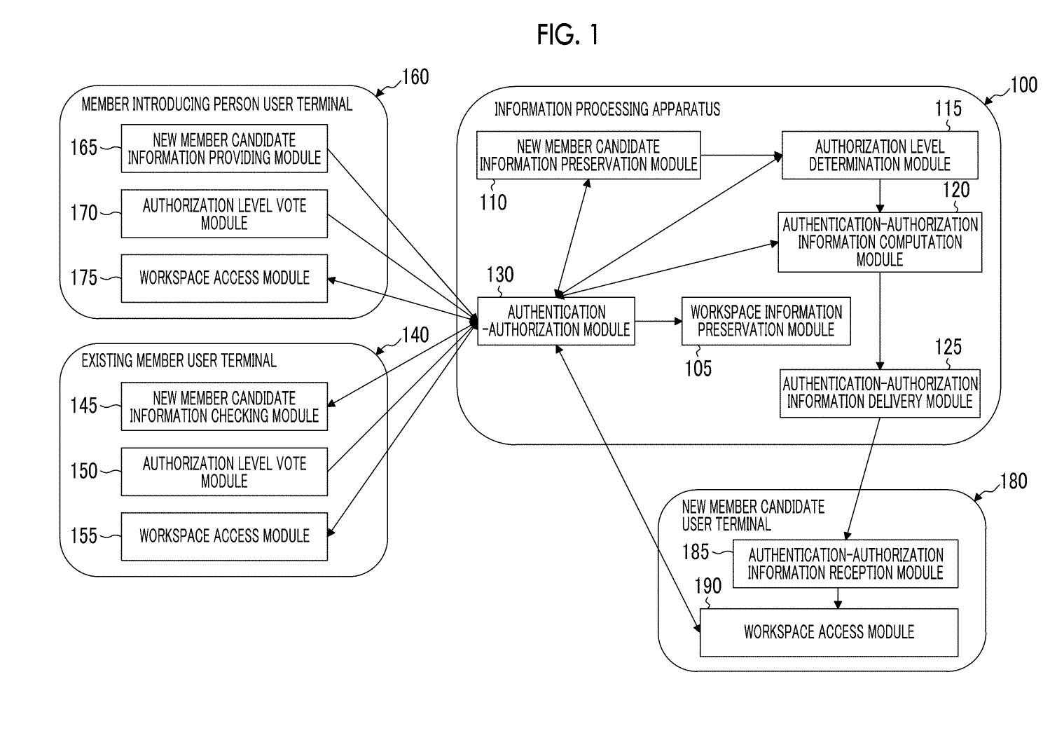

FIG. 1 is a conceptual module configuration diagram for a configuration example of a first exemplary embodiment.

The module generally indicates components such as software (computer program) or hardware which can be logically divided. Therefore, the module in the present exemplary embodiment indicates not only a module in a computer program but also a module in a hardware configuration. Therefore, in the present exemplary embodiment, a description will also be made of a computer program (a program causing a computer to execute each procedure, a program causing a computer to each unit, or a program a computer to realize each function), a system, and a method for functioning as such a module. However, for convenience of description, “storing”, “being stored”, or words equivalent thereto are used, but, these words indicate that a storage device stores data or a storage device is controlled to store data in a case where an exemplary embodiment is a computer program. A module may correspond to a function on a one-to-one basis, and, in installation, a single module may be configured with a single program, a plurality of modules may be configured with a single program, and, conversely, a single module may be configured with a plurality of programs. A plurality of modules may be executed by a single computer, and a single module may be executed by a plurality of computers in a distributed or parallel environment. Other modules may be included in a single module. Hereinafter, the term “connection” indicates only physical connection but also logical connection (transmission and reception of data, indication, a reference relationship between pieces of data, login, and the like). The term. “setting in advance” indicates that setting is performed prior to a target process, and indicates not only that setting is performed before a process according to the present exemplary embodiment is started but also that, even after a process according to the present exemplary embodiment is started, setting is performed depending on a situation or a state at the time or a situation or a state hitherto in a case where a target process is not performed. In a case where there are “a plurality of preset values”, the values may be different from each other, and two or more values may be the same as each other (of course, including all of the values). The description that “in a case of A, B is performed” indicates that “it is determined whether or not A is satisfied, and, in a case where it is determined that A is satisfied, B is performed”. However, this excludes a case where determination of whether or not A is satisfied is unnecessary. In a case where objects are listed such as “A, B, and C”, the objects are exemplarily listed unless otherwise mentioned, and a case where only one thereof (for example, only A) is selected is included.

A system or an apparatus also includes not only a case where a plurality of computers, pieces of hardware, and apparatuses are configured to be connected to each other via a communication unit such as a network (including communication connection on a one-to-one basis) but also a case of being configured with a single computer, a single piece of hardware, and a single apparatus. The “apparatus” and the “system” are used as terms having an identical meaning. Of course, the “system.” does not include systems that are merely a social “mechanism” (social system) which is an artificial arrangement.

Target information is read from a storage device, the process is performed, and a process result is written to the storage device for each process performed by each module or for each process in a case where a plurality of processes are performed in a module. Therefore, description of reading for a storage device before a process and writing for the storage device after the process will be omitted. The storage device here may include a hard disk, a random access memory (RAM), an external storage medium, a storage device connected via a communication line, a register in a central processing unit (CPU), or the like.

An information processing apparatus 100 according to a first exemplary embodiment is used for a so-called collaboration system (also referred to as a groupware system), and is one configuration of a system including the information processing apparatus 100, an existing member user terminal 140, a member introducing person user terminal 160, and a new member candidate user terminal 180 as illustrated in an example in FIG. 1.

The collaboration system is a system supporting correlated with performed by a plurality of users via a communication line. Generally, the collaboration system has functions such as an electronic mail, a bulletin board, an electronic conference, schedule management, a document database, a workflow, and project management, for the purpose of information sharing or communication. However, the collaboration system is not required to have all of the functions.

Particularly, in the first exemplary embodiment, a workspace (an example of a group of a plurality of persons; also referred to as a group) is already built, and then a process regarding whether or not a new member is allowed to subscribe is performed. Specifically, in the first exemplary embodiment, in a case where a new member participates in the workspace, the new member is given appropriate information access authority with the consent of existing members. The new member does not know the past story in the workspace, and the information processing apparatus 100 determines a disclosure scope of the past information.

The information processing apparatus 100 includes a workspace information preservation module 105, a new member candidate information preservation module 110, an authorization level determination module 115, an authentication-authorization information computation module 120, an authentication-authorization information delivery module 125, and an authentication-authorization module 130. The information processing apparatus 100 functions as a collaboration system.

The workspace information preservation module 105 is connected to the authentication-authorization module 130. The workspace information preservation module 105 has a function of preserving information regarding a workspace in the information processing apparatus 100. Here, the “information regarding a workspace” includes, for example, information such as a workspace name, a member of the workspace, messages or documents exchanged in the workspace, and an access right of a workspace participant to the messages or the documents.

The authentication-authorization module 130 is connected to the workspace information preservation module 105, the new member candidate information preservation module 110, the authorization level determination module 115, the authentication-authorization information computation module 120, a new member candidate information checking module 145, an authorization level vote module 150, and a workspace access module 155 of the existing member user terminal 140, a new member candidate information providing module 165, an authorization level vote module 170, and a workspace access module 175 of the member introducing person user terminal 160, and a workspace access module 190 of the new member candidate user terminal 180. The authentication-authorization module 130 discloses information regarding a member candidate who wants to subscribe to a group of a plurality of persons as a new member, to an existing member (a user of the existing member user terminal 140). The authentication-authorization module 130 accepts authorizable authority for the member candidate from the existing member viewing the disclosed information. Here, the “group” is a workspace including a plurality of persons. The “authorizable authority” indicates, for example, a result of votes taken by members.

For example, in a case where a member accesses the workspace of the information processing apparatus 100, the authentication-authorization module 130 has functions of authenticating a member and restricting an operation in the workspace according to an authorization level assigned to the member. Authentication-authorization information which will be described later is sent to the authentication-authorization module 130 during access from a member, and authentication and an operation restriction are performed on the basis thereof.

The authorization level determination module 115 is connected to the new member candidate information preservation module 110, the authentication-authorization information computation module 120, and the authentication-authorization module 130. The authorization level determination module 115 determines an authority (also referred to as an authorization level) to be assigned to a member candidate according to an authorizable authority. The authority determined by the authorization level determination module 115 indicates authority for an operation in the group.

The authorization level determination module 115 may determine authority by using information disclosed by disclosure means.

The authorization level determination module 115 may determine that predefined authority is not assigned in a case where there is no disclosure of a predefined item. For example, in a case where a nickname is disclosed, but a name is not disclosed or a face picture is not disclosed, authority to access the past information may not be assigned. In a case where the name of a user is disclosed, access to all pieces of information may be permitted. Here, the “past information” may be, for example, messages (specifically, electronic mails or chats in the workspace) exchanged between members, or documents (specifically, documents registered in the workspace) created by a member. The document (also referred to as a file) is text data, numerical value data, graphic data, image data, moving image data, audio data, or a combination thereof, refers to an object which can be changed in the individual unit between workspaces or users as a target of storage, editing, and retrieval, and includes objects similar thereto. Specifically, the document includes a document created by a document creation program (so-called word-processing software), an image read by an image reading apparatus (scanner or the like), a web page, or the like.

The authority determined by the authorization level determination module 115 may include access authority to the past information in a group.

The authorization level determination module 115 may determine authority through statistical processing for authorizable authority. The “statistical processing” may include one or more of decision by majority, a weight according to an existing member, or a logical operation.

For example, the authorization level determination module 115 has a function of determining and storing an authorization level assigned to a new member candidate on the basis of a result of existing members takes votes by using the authorization level vote module 150 and the authorization level vote module 170.

Regarding a determination method, the highest authorization level derived by logical product of votes may be determined, and the lowest authorization level derived by logical sum of votes may be determined. The determined authorization level is preserved, for example, as the following tagged text.

<Member sex=“OO” name=“OO” mail address = “ΔΔ@XX.OO”.../>
<authorization level>
<workspace ID=“OO” name = “OO”>
<message authority=“ReadWriteDelete”/>
<document>
<classification ID=“XX” name=“XX” authority=“Read”/>
<classification ID“●●” name=“●●”

authority=“ReadWrite”/>

...
</document>
</workspace>
<workspace ID=“ΔΔ” name=“ΔΔ”>
...
</workspace>
...</authorization level>

The new member candidate information preservation module 110 is connected to the authorization level determination module 115 and the authentication-authorization module 130. The new member candidate information preservation module 110 has a function of preserving information (“information regarding a new member candidate” which will be described later) provided from the new member candidate information providing module 165 of the member introducing person user terminal 160 in the information processing apparatus 100.

The information preserved in the new member candidate information preservation module 110 is expressed, for example, by the following tagged text.
<Member sex=“OO” name=“OO” mail address=“ΔΔ@XX.OO” . . . >

The authentication-authorization information computation module 120 is connected to the authorization level determination module 115, the authentication-authorization information delivery module 125, and the authentication-authorization module 130. The authentication-authorization information computation module 120 generates identification information for unique identification by using authority determined by the authorization level determination module 115. In other words, the authentication-authorization information computation module 120 has a function of computing authentication-authorization information. Here, the “authentication-authorization information” is a computation value which is uniquely obtained on the basis of information preserved in the authorization level determination module 115. In the above example of the text with the tag, a hash value obtained by inputting the text data is used as the authentication-authorization information.

The authentication-authorization information delivery module 125 is connected to the authentication-authorization information computation module 120, and an authentication-authorization information reception module 185 of the new member candidate user terminal 180. The authentication-authorization information delivery module 125 transmits identification information generated by the authentication-authorization information computation module 120 to a member candidate (a user of the new member candidate user terminal 180). Specifically, the authentication-authorization information delivery module 125 has a function of transmitting the authentication-authorization information preserved by the authentication-authorization information computation module 120 to the new member candidate user terminal 180.

After the authentication-authorization information is transmitted, the authentication-authorization module 130 receives information from the member candidate (the user of the new member candidate user terminal 180).

In a case where the identification information matches the received information, the authentication-authorization module 130 authorizes the member candidate as a member of the group.

In a case where the member candidate is authorized, the authentication-authorization module 130 permits the member candidate (the user authorized as a member) authority determined by the authorization level determination module 115.

The existing member user terminal 140 includes the new member candidate information checking module 145, the authorization level vote module 150, and the workspace access module 155. The existing member user terminal 140 is an information terminal which is able to perform communication with the information processing apparatus 100 and is used by an existing member (a member other than an introducing person of a new member candidate) of the workspace.

The new member candidate information checking module 145 is connected to the authentication-authorization module 130 of the information processing apparatus 100. The new member candidate information checking module 145 has a function in which an existing member other than a member who intends to invite the new member candidate checks information regarding a new member candidate held in the new member candidate information preservation module 110.

The authorization level vote module 150 is connected to the authentication-authorization module 130 of the information processing apparatus 100. The authorization level vote module 150 has a function of a vote for expressing intention regarding an authorization level which each existing member wants to assign to a new member candidate. For example, each existing member selects and votes on reading authority, writing authority, and deletion authority to be assigned to the new member candidate with respect to messages and documents in the workspace. Here, each piece of authority may be assigned with respect to the entire workspace, and authority may be assigned by separating messages from documents. In a case where messages and documents are classified by priority, a case, or the like, authority may be assigned with respect to each classification.

A graphical user interface (GUI) for selection may be realized in a form of a pull-down menu or a checkbox.

The workspace access module 155 is connected to the authentication-authorization module 130 of the information processing apparatus 100. The workspace access module 155 has a function of enabling a member (an existing member of the workspace in the existing member user terminal 140) to access the workspace of the information processing apparatus 100, and thus to exchange messages with another member (a user of another existing member user terminal 140 or a user of the member introducing person user terminal 160), and to register, edit, and delete documents.

The member introducing person user terminal 160 includes the new member candidate information providing module 165, the authorization level vote module 170, and the workspace access module 175. The member introducing person user terminal 160 is an information terminal which is able to perform communication with the information processing apparatus 100, and is used by an existing member of the workspace as an introducing person of a new member candidate.

The new member candidate information providing module 165 is connected to the authentication-authorization module 130 of the information processing apparatus 100. The new member candidate information providing module 165 has a function in which an existing member who wants to invite a new member candidate provides information regarding the new member candidate. Here, the “information regarding the new member candidate” is information for specifying the person, and includes, for example, a name, a mail address, a telephone number, a face picture, an organization, and an official position.

The authorization level vote module 170 is connected to the authentication-authorization module 130 of the information processing apparatus 100. The authorization level vote module 170 has an equivalent function to that of the authorization level vote module 150 of the existing member user terminal 140.

The workspace access module 175 is connected to the authentication-authorization module 130 of the information processing apparatus 100. The workspace access module 175 has a function of enabling a member (an existing member of the workspace and a new member introducing person in the member introducing person user terminal 160) to access the workspace of the information processing apparatus 100, and thus to exchange messages with another member, and to register, edit, and delete documents.

The new member candidate user terminal 180 is connected to the authentication-authorization information reception module 185 and the workspace access module 190. The new member candidate user terminal 180 is an information terminal which is able to perform communication with the information processing apparatus 100, and is used by a new member candidate who is not a member of the workspace.

The authentication-authorization information reception module 185 is connected to the authentication-authorization information delivery module 125 of the information processing apparatus 100, and the workspace access module 190. The authentication-authorization information reception module 185 has a function of receiving authentication-authorization information delivered from the authentication-authorization information delivery module 125. The received authentication-authorization information is sent to the authentication-authorization module 130 in a case where a new member candidate accesses the information processing apparatus 100 by using the workspace access module 190. When this is an accurate value, it is possible to access the workspace of the information processing apparatus 100 with an assigned authorization level.

The workspace access module 190 is connected to the authentication-authorization module 130 of the information processing apparatus 100, and the authentication-authorization information reception module 185. The workspace access module 190 has a function of enabling a member (in the new member candidate user terminal 180, a member who is not registered in the workspace and is a new member candidate, and an existing member in a case of being admitted as a member) to access the workspace of the information processing apparatus 100, and thus to exchange messages with another member, and to register, edit, and delete documents.

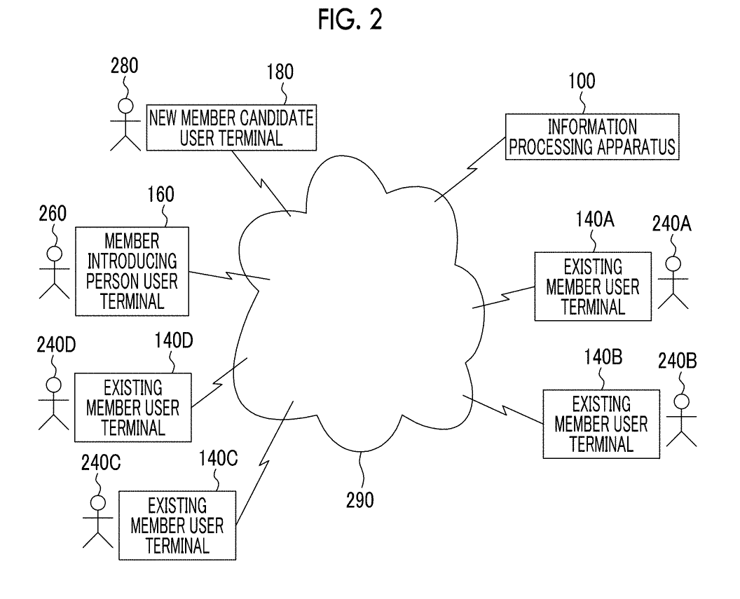

FIG. 2 is a diagram illustrating a system configuration example according to the present exemplary embodiment.

The information processing apparatus 100, an existing member user terminal 140A, an existing member user terminal 140B, an existing member user terminal 140C, an existing member user terminal 140D, the member introducing person user terminal 160, and the new member candidate user terminal 180 are connected to each other via a communication line 290. The communication line 290 may be a wireless line, a wired line, or a combination thereof, and may be, for example, the Internet or an intranet as a communication infrastructure. The functions of the information processing apparatus 100 may be realized by a cloud service.

For example, the workspace is formed by a user 240A to a user 240D (users of the respective existing member user terminals 140), and a user 260 (a user of the member introducing person user terminal 160). The user 260 is one of existing members, and is an introducing person of a user 280. The user 280 (a user of the new member candidate user terminal 180) wants to be a new member of the workspace. The information processing apparatus 100 determines whether or not to accept the user 280 introduced by the user 260 as a member of the workspace, and determines an authorization level in a case where the user 280 is accepted as a member, according to votes of the users 240.

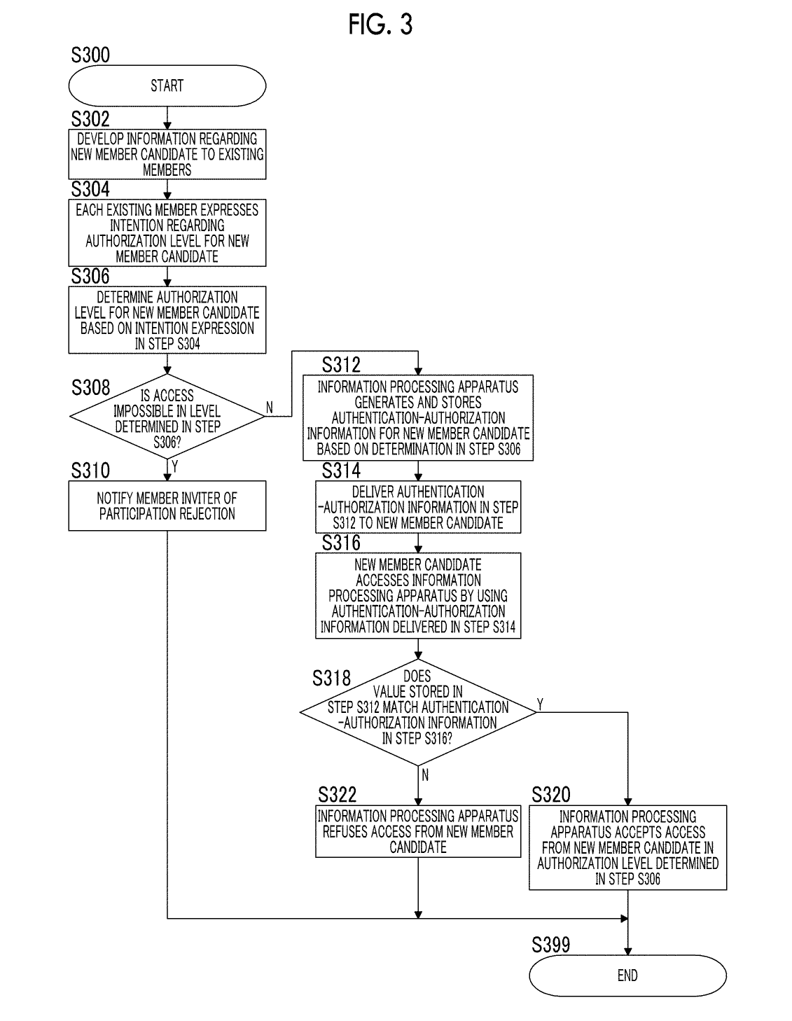

FIG. 3 is a flowchart illustrating a process example according to the first exemplary embodiment.

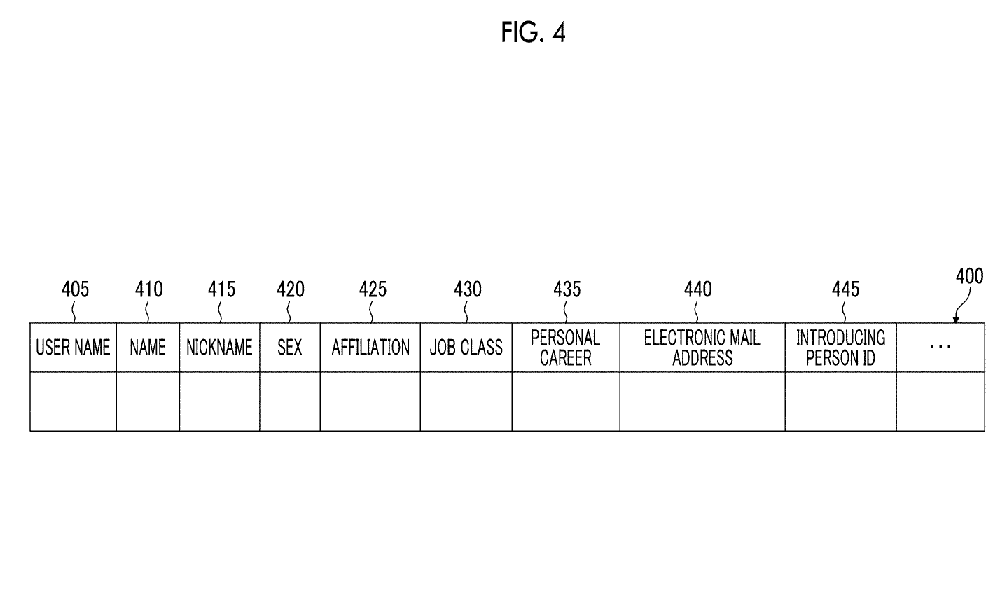

In step S302, information regarding a new member candidate is developed to existing members. For example, the information regarding the new member candidate (the user 280 of the new member candidate user terminal 180) provided to the information processing apparatus 100 from the member introducing person user terminal 160 is transmitted to the existing member user terminal 140 (generally, a plurality of existing member user terminals 140) from the information processing apparatus 100. For example, a user information table 400 is transmitted as the information regarding the new member candidate. FIG. 4 is a diagram illustrating a data structure example of the user information table 400. The user information table 400 has a user name field 405, a name field 410, a nickname field 415, a sex field 420, an affiliation field 425, a job class field 430, a personal career field 435, an electronic mail address field 440, an introducing person ID field 445, and the like. The user name field 405 stores a user name (which may be a user identification (ID)) of a new member candidate. The name field 410 stores the name of the user. The nickname field 415 stores a nickname of the user. The sex field 420 stores the sex of the user. The affiliation field 425 stores an affiliation of the user. The job class field 430 stores a job class of the user. The personal career field 435 stores a personal career of the user. The electronic mail address field 440 stores an electronic mail address of the user. The introducing person ID field 445 stores information (introducing person ID) for uniquely identifying an introducing person in the present exemplary embodiment. All pieces of information in the user information table 400 is not required to be set. There is a case where a name or the like is not set by a new member candidate or an introducing person (in a case where the name or the like is not disclosed or concealed).

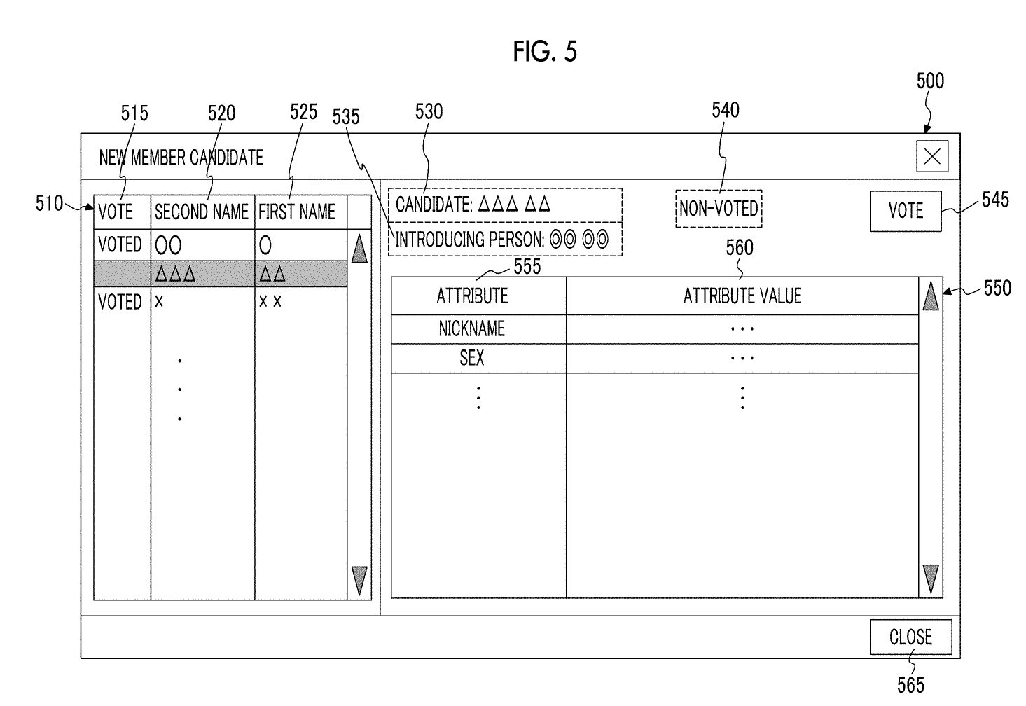

The existing member user terminal 140 receiving the user information table 400 displays, for example, a new member candidate information checking screen 500 on a display device of the existing member user terminal 140. FIG. 5 is a diagram illustrating a presentation example of the new member candidate information checking screen 500. A new member candidate list 510, a candidate field 530, an introducing person field 535, a voted/non-voted field 540, a vote button 545, a candidate information table 550, and a close button 565 are displayed in the new member candidate information checking screen 500.

The new member candidate list 510 has a vote field 515, a second name field 520, and a first name field 525. Information regarding whether or not voting on the new member candidate is completed is displayed in the vote field 515. The “voting” will be described later in step S304. By using the name field 410 of the user information table 400, a second name of the new member candidate is displayed in the second name field 520, and a first name of the new member candidate is displayed in the first name field 525. For example, in a case where the name field 410 of the user information table 400 is blank, a nickname or a user name (the nickname field 415 or the user name field 405 of the user information table 400) may be displayed instead of a name.

In a case where selection of one among new member candidates is detected in the new member candidate list 510, detailed information is displayed in a right pane (a region partitioned on the basis of a function in the window inside on a graphical user interface (GUI), and, in the example illustrated in FIG. 5, the candidate information table 550).

A new member candidate is displayed in the candidate field 530, and the name of an existing member introducing the new member candidate is displayed in the introducing person field 535.

In the voted/non-voted field 540, either “voted” or “non-voted” is displayed with respect to the new member candidate selected in the new member candidate list 510.

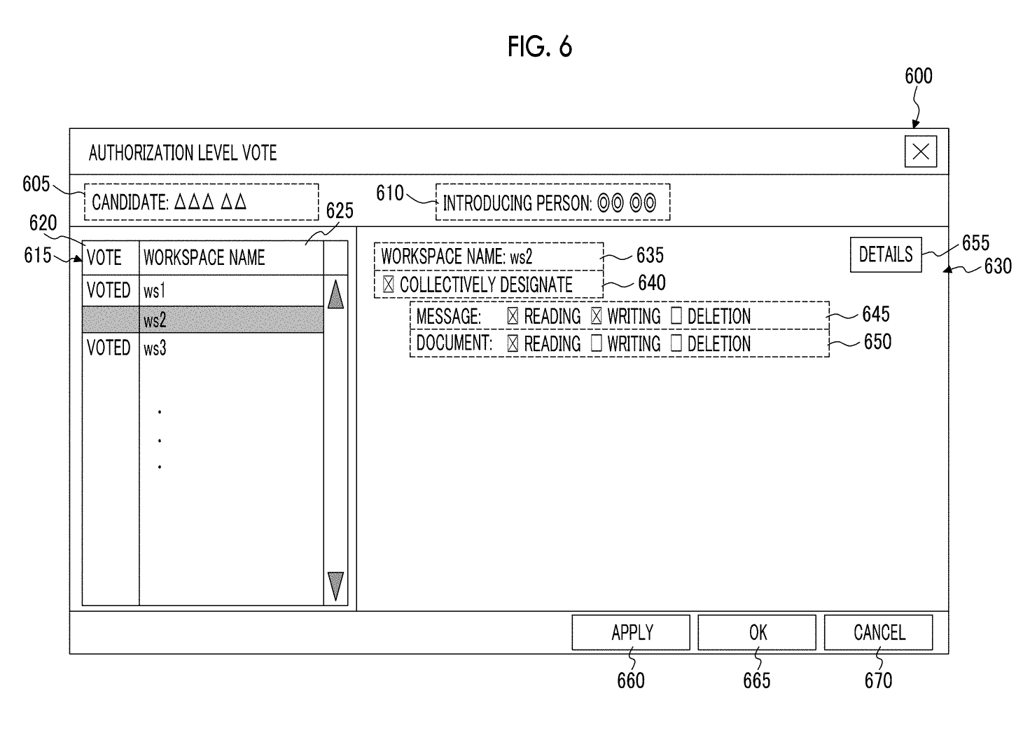

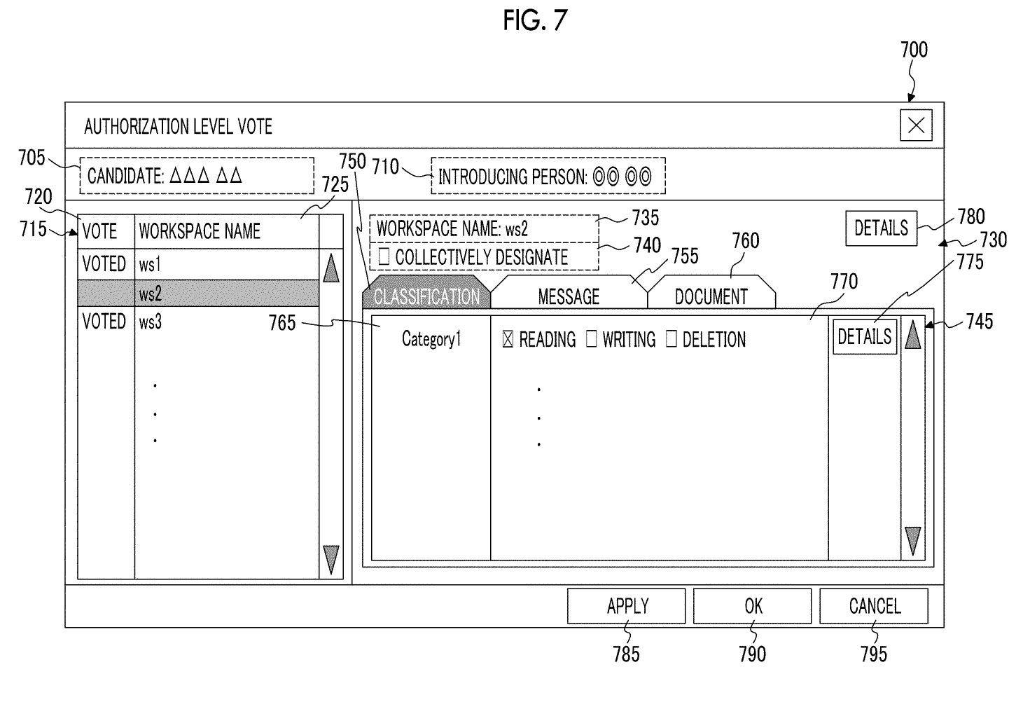

In a case where pressing of the vote button 545 is detected, an authorization level vote screen 600 illustrated in an example in FIG. 6 or an authorization level vote screen 700 illustrated in an example in FIG. 7 is displayed, and thus a vote on an authorization level is taken.

The candidate information table 550 has an attribute field 555 and an attribute value field 560. An attribute is displayed in the attribute field 555. An attribute value is displayed in the attribute value field 560.

Information regarding the new member candidate is displayed in the candidate information table 550. For example, data in the user information table 400 is displayed. For example, in a case of XML data, an attribute of an XML element corresponding to the candidate is displayed in a left column, and an attribute value is displayed in a right column.

In a case where pressing of the close button 565 is detected, the new member candidate information checking screen 500 is closed.

In step S304, each existing member expresses intention regarding an authorization level for the new member candidate. For example, in a case where pressing of the vote button 545 on the new member candidate information checking screen 500 illustrated in FIG. 5 is detected, the authorization level vote screen 600 or the authorization level vote screen 700 illustrated in the example in FIG. 6 or 7 is displayed, and a vote (an example of expression of intention) on an authorization level is taken. The authorization level vote screen 600 illustrated in the example in FIG. 6 corresponds to a display example in a case where a collective designation region 640 is in an ON state, and the authorization level vote screen 700 illustrated in the example in FIG. 7 corresponds to a display example in a case where a collective designation region 740 (equivalent to the collective designation region 640 in FIG. 6) is in an OFF state.

FIG. 6 is a diagram illustrating a presentation example of the authorization level vote screen 600. In the authorization level vote screen 600, a candidate field 605, an introducing person field 610, a workspace list 615, a workspace-based authorization level vote region 630, an apply button 660, an OK button 665, and a cancel button 670 are displayed.

The workspace list 615 has a vote field 620 and a workspace name field 625. Information indicating whether or not voting is completed is displayed in the vote field 620. The name of a workspace on which an operator has a right to vote and to which a new member candidate wants to subscribe is displayed in the workspace name field 625. The “workspace on which an operator has a right to vote” is, specifically, a workspace in which the operator is a member.

Equivalent display to display in the candidate field 530 and the introducing person field 535 illustrated in the example in FIG. 5 is performed in the candidate field 605 and the introducing person field 610.

In a case where selection of one workspace is detected in the workspace list 615, a screen for voting on the workspace is displayed in the workspace-based authorization level vote region 630 of the right pane.

A workspace name display region 635, the collective designation region 640, a message authorization level vote region 645, a document authorization level vote region 650, and a details button 655 are displayed in the workspace-based authorization level vote region 630.

The name of the workspace (in the example in FIG. 6, “ws2”) selected in the workspace list 615 is displayed in the workspace name display region 635.

In a case where it is detected that a checkbox is in an ON state in the collective designation region 640, checkboxes for collectively designating authorization levels for all messages and all documents in the workspace are displayed.

In the message authorization level vote region 645 and the document authorization level vote region 650, the checkboxes are displayed such that a user is able to designate ON or OFF for each of “reading”, “writing”, and “deletion” with respect to all of the messages and all of the documents. In other words, an operator (an existing member of the workspace) is able to collectively vote (with respect to all of the messages and all of the documents) on authority assigned to a new member candidate.

In a case where pressing of the details button 655 is detected, property information (a creation date, a purpose, a participant, and the like) of the workspace is displayed on a separate screen.

In a case where pressing of the apply button 660 is detected, selection at that time is voted, but the authorization level vote screen 600 is not closed.

In a case where pressing of the OK button 665 is detected, selection at that time is voted, and the authorization level vote screen 600 is closed.

In a case where pressing of the cancel button 670 is detected, selection at that time is discarded, a vote is not taken, and the authorization level vote screen 600 is closed.

FIG. 7 is a diagram illustrating a presentation example of the authorization level vote screen 700. In the authorization level vote screen 700, a candidate field 705, an introducing person field 710, a workspace list 715, a workspace-based authorization level vote region 730, an apply button 785, an OK button 790, and a cancel button 795 are displayed.

Equivalent display to display in the candidate field 605, the introducing person field 610, the workspace list 615, the vote field 620, and the workspace name field 625 illustrated in the example in FIG. 6 is performed in the candidate field 705, the introducing person field 710, the workspace list 715, the vote field 720, and the workspace name field 725.

A workspace name display region 735, the collective designation region 740, an authorization level vote region 745, and a details button 780 are displayed in the workspace-based authorization level vote region 730.

In a case where it is detected that a checkbox is in an OFF state in the collective designation region 740, checkboxes are displayed such that voting on an access right for each classification and each of messages and documents can be performed.

In the authorization level vote region 745, a vote on authority for a classification, a message, and a document is changed with a tab. In the respective tabs, respective names (names of the classification, the message, and the document) are displayed in a list form in a name field 765, and are displayed such that an authorization level can be designated in the authorization level vote field 770.

In a case where pressing of the details button 775 is detected, property information of each of the classification, the message, and the document is displayed on a separate screen.

Equivalent display to display in the details button 655, the apply button 660, the OK button 665, and the cancel button 670 illustrated in the example in FIG. 6 is performed in the details button 780, the apply button 785, the OK button 790, and the cancel button 795.

A UI for determining subscription of a new member candidate to the workspace is not displayed on the authorization level vote screen 600 or the authorization level vote screen 700, but, in a case where no authority is set, this indicates that an operator does not admit subscription (“Y” in step S308), and, in a case where certain authority is set, this indicates that an operator admits at least subscription (“N” in step S308). A UI (a button indicating a subscription approval or the like) for expressing approval or contrary intention for subscription of a new member candidate to the workspace may be displayed on the authorization level vote screen 600 or the authorization level vote screen 700.

In step S306, an authorization level for the new member candidate is determined on the basis of the intention expression (a vote result in the workspace-based authorization level vote region 630 or the workspace-based authorization level vote region 730 illustrated in the example in FIG. 6 or 7) in step S304. As described above, an authorization level for the new member candidate is determined through the statistical processing including one or more of decision by majority, a weight according to an existing member, or a logical operation. Regarding the “weight according to an existing member”, for example, a weight value (for example, a vote of a leader is A (where A is a value of 1 or greater) more than that of a general member) may be determined according to a status (for example, a leader or a general member) in the workspace, and decision by majority may be made. Regarding the logical operation, all members have voted (so-called logical product; AND), and any one has voted (so-called logical sum; OR).

In step S308, it is determined whether or not access is impossible in the level determined in step S306, and, in a case where access is impossible, the flow proceeds to step S310, and, in other cases, the flow proceeds to step S312.

In step S310, a member inviter is notified of a participation rejection, and the process is finished (step S399).

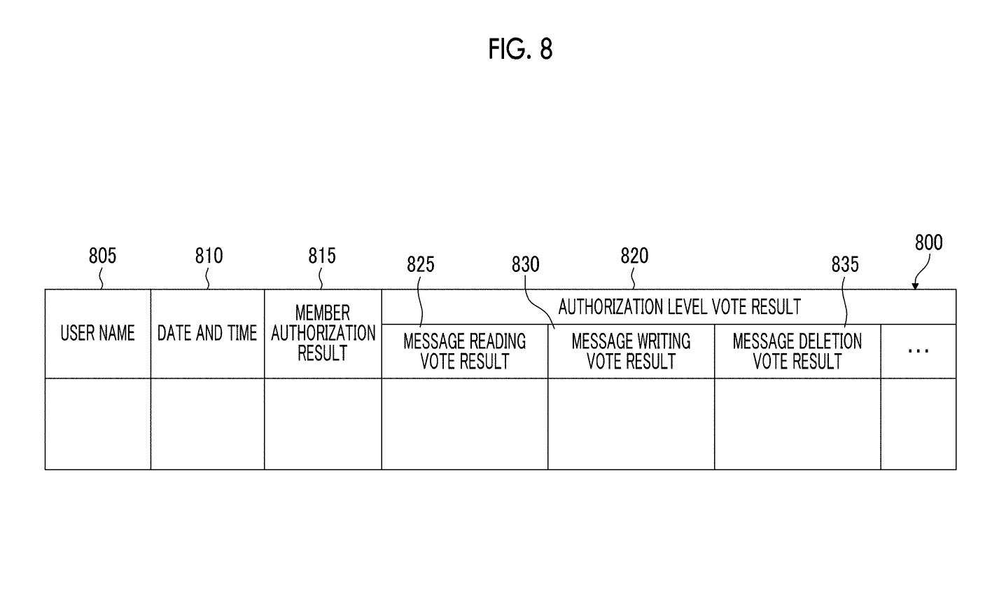

In step S312, the information processing apparatus 100 generates and stores authentication-authorization information for a new member candidate on the basis of the determination in step S306. For example, a vote result table 800 is generated and stored. FIG. 8 is a diagram illustrating a data structure example of the vote result table 800. The vote result table 800 has a user name field 805, a date and time field 810, a member authorization result field 815, and an authorization level vote result field 820, and the authorization level vote result field 820 has a message reading vote result field 825, a message writing vote result field 830, a message deletion vote result field 835, and the like. The user name field 805 stores a user name. The date and time field 810 stores the date and time (which may be year, month, day, hour, minute, second, second or less, or a combination thereof) at which an authorization level is determined. The member authorization result field 815 stores a member authorization result (the authorization level determined in step S306). The authorization level vote result field 820 stores an authorization level vote result (the vote result in step S306). The message reading vote result field 825 stores a vote result for message read authority. The message writing vote result field 830 stores a vote result for message write authority. The message deletion vote result field 835 stores a vote result for message delete authority. Authority (reading, writing, and deletion) on documents, and authority on each message and each document are stored.

In step S314, the authentication-authorization information in step S312 is delivered to the new member candidate. Here, the authentication-authorization information is an example of the above-described “identification information for unique identification”, and may be, for example, a hash value of information of the vote result table 800.

In step S316, the new member candidate accesses the information processing apparatus 100 by using the authentication-authorization information delivered in step S314. The authentication-authorization information is used as information for login. Specifically, an entry field for the authentication-authorization information is provided on a login screen such that the authentication-authorization information from the new member candidate can be accepted.

In step S318, it is determined whether or not the value stored in step S312 matches the authentication-authorization information in step S316, and, in a case where the value matches the authentication-authorization information, the flow proceeds to step S320, and, in other cases, the flow proceeds to step S322.

In step S320, the information processing apparatus 100 accepts access from the new member candidate in the authorization level determined in step S306.

In step S322, the information processing apparatus 100 refuses access from the new member candidate.

In step S306, an authorization level for the new member candidate may be determined on the basis of intention expression of the existing member and the information disclosed in step S302. As described above, in a case where a nickname is disclosed but a name is not disclosed, an authorization level may not be admitted. Similarly, in a case where a nickname is disclosed but a name is not disclosed, an upper limit authorization level may be set in advance, an authorization level may be determined within a range below or equal to or lower than the authorization level by using intention expression of an existing member.

### Second Exemplary Embodiment

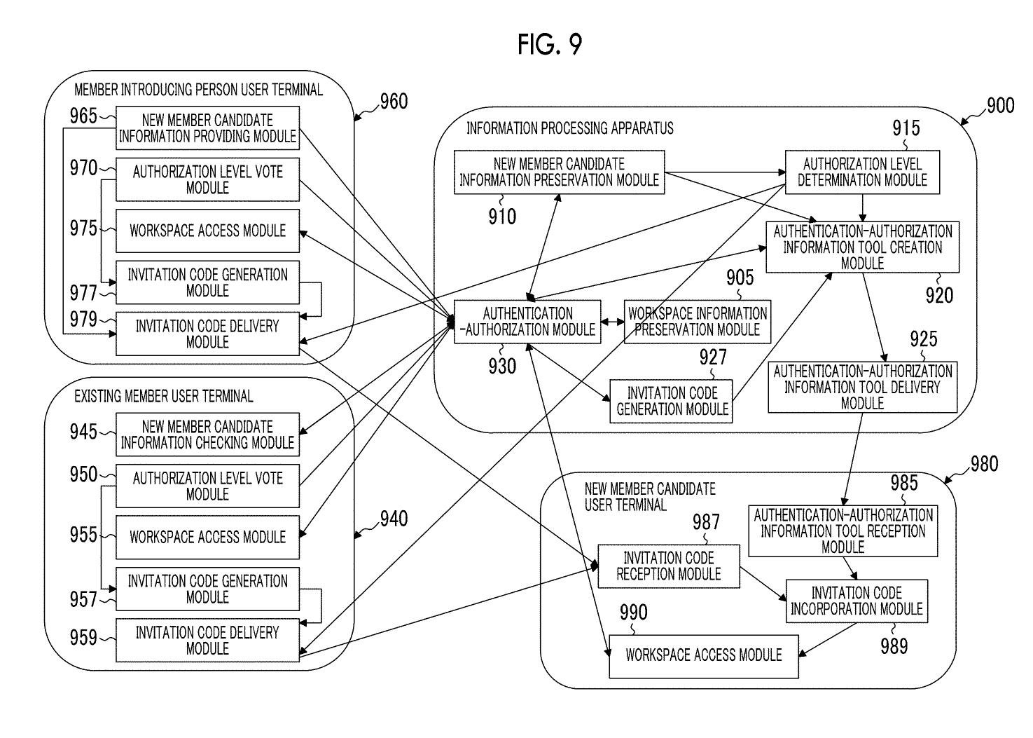

FIG. 9 is a conceptual module configuration diagram for a configuration example of a second exemplary embodiment.

In the second exemplary embodiment, a process is added to the first exemplary embodiment, the process in which a member candidate is authorized as a member of a group on the condition that invitation card information (hereinafter, also referred to as an invitation code) transmitted from an existing member is included. Consequently, it is possible to reduce an opportunity for a malicious third party to acquire information in a group and thus to make spoofing difficult.

In the same type of part as in the first exemplary embodiment, the module will be pointed out and repeated description will be omitted.

An information processing apparatus 900 includes a workspace information preservation module 905, a new member candidate information preservation module 910, an authorization level determination module 915, an authentication-authorization information tool creation module 920, an authentication-authorization information tool delivery module 925, an invitation code generation module 927, and an authentication-authorization module 930.

The workspace information preservation module 905 is connected to the authentication-authorization module 930. The workspace information preservation module 905 has a function equivalent to the function of the workspace information preservation module 105 exemplified in FIG. 1.

The new member candidate information preservation module 910 is connected to the authorization level determination module 915, the authentication-authorization information tool creation module 920, and the authentication-authorization module 930. The new member candidate information preservation module 910 has a function equivalent to the function of the new member candidate information preservation module 110 exemplified FIG. 1.

The authorization level determination module 915 is connected to the new member candidate information preservation module 910, the authentication-authorization information tool creation module 920, an invitation code delivery module 959 of an existing member user terminal 940, and an invitation code delivery module 979 of a member introducing person user terminal 960. The authorization level determination module 915 has a function equivalent to the function of the authorization level determination module 115 exemplified in FIG. 1, and also instructs the invitation code delivery module 959 or the invitation code delivery module 979 present in a client of each existing member to deliver an invitation code to a new member candidate in cases other than a case where access is not possible in a determined authorization level.

The authentication-authorization information tool creation module 920 is connected to the new member candidate information preservation module 910, the authorization level determination module 915, the authentication-authorization information tool delivery module 925, the invitation code generation module 927, and the authentication-authorization module 930. The authentication-authorization information tool creation module 920 has a function equivalent to the function of the authentication-authorization information computation module 120 exemplified FIG. 1. In the second exemplary embodiment, the authentication-authorization information tool creation module 920 has a function of computing a unique value on the basis of a determined authorization level, and also creating and preserving a tool including a computation formula having the unique value and an invitation code as inputs.

Here, a method of computing a unique value is the same as in the authentication-authorization information computation module 120 of the first exemplary embodiment.

A computation formula in the second exemplary embodiment employs a formula obtained by sequentially connecting respective invitation codes to each other up to the end by using character strings with a unique value obtained on the basis of an authorization level as the head. A result of connecting all values to each other is used as authentication-authorization information in the second exemplary embodiment.

Information indicating a connection order of an invitation code of a certain member is recorded in a tool. This information may be expressed by arranging values (for example, mail addresses) uniquely indicating users in a tagged text form.

The authentication-authorization information tool delivery module 925 is connected to the authentication-authorization information tool creation module 920, and an authentication-authorization information tool reception module 985 of a new member candidate user terminal 980. The authentication-authorization information tool delivery module 925 has a function equivalent to the function of the authentication-authorization information delivery module 125 exemplified in FIG. 1. The authentication-authorization information tool delivery module 925 has a function of delivering a tool created by the authentication-authorization information tool creation module 920 to the new member candidate user terminal 980. During delivery, only a unique value obtained on the basis of an authorization level is incorporated into a tool computation formula, and an invitation code is not incorporated thereinto.

The invitation code generation module 927 is connected to the authentication-authorization information tool creation module 920 and the authentication-authorization module 930. The invitation code generation module 927 generates an invitation code used for each existing member to invite a new member candidate. As will be described later, an invitation code is used as an input for computing authentication-authorization information, and an accurate value can be computed when all invitation codes are arranged. This achieves an effect that it is hard for a malicious third party to take information, and thus to prevent the malicious third party from causing spoofing by configuring authentication-authorization information.

The invitation code here is a hash value having information indicating an authorization level on which each existing member votes as an input. The “information indicating an authorization level” here is tagged text such as <authorization level> . . . </authorization level> shown in the data example described in the example of the first exemplary embodiment.

The invitation code generation module 927 of the information processing apparatus 900 has the same computation logic as that of an invitation code generation module 957 or an invitation code generation module 977 present in each existing member user terminal, and generates an invitation code of a member on the basis of a vote of the member. In other words, an existing member does not directly perform communication of an invitation code with the information processing apparatus 900.

The authentication-authorization module 930 is connected to the workspace information preservation module 905, the new member candidate information preservation module 910, the authentication-authorization information tool creation module 920, and the invitation code generation module 927; a new member candidate information checking module 945, an authorization level vote module 950, and a workspace access module 955 of the existing member user terminal 940; a new member candidate information providing module 965, an authorization level vote module 970, and a workspace access module 975 of the member introducing person user terminal 960; and a workspace access module 990 of the new member candidate user terminal 980. The authentication-authorization module 930 has a function equivalent to the function of the authentication-authorization module 130 exemplified in FIG. 1, and may also authorize a new member candidate as a member on the condition that an invitation code transmitted from an existing member (a user of the existing member user terminal 940 or the member introducing person user terminal 960) is included in information received from the new member candidate user terminal 980.

Specifically, determination of authentication and authorization in the authentication-authorization module 930 is performed on the basis of whether or not authentication-authorization information assembled by using a tool preserved in the information processing apparatus 900 matches authentication-authorization information presented from the new member candidate.

The existing member user terminal 940 includes the new member candidate information checking module 945, the authorization level vote module 950, the workspace access module 955, the invitation code generation module 957, and the invitation code delivery module 959. The existing member user terminal 940 is an information terminal which is able to perform communication with the information processing apparatus 900 and is used by an existing member (a member other than an introducing person of a new member candidate) of the workspace.

The new member candidate information checking module 945 is connected to the authentication-authorization module 930 of the information processing apparatus 900. The new member candidate information checking module 945 has a function equivalent to the function of the new member candidate information checking module 145 exemplified in FIG. 1.

The authorization level vote module 950 is connected to the invitation code generation module 957, and the authentication-authorization module 930 of the information processing apparatus 900. The authorization level vote module 950 has a function equivalent to the function of the authorization level vote module 150 exemplified in FIG. 1.

The workspace access module 955 is connected to the authentication-authorization module 930 of the information processing apparatus 900. The workspace access module 955 has a function equivalent to the function of the workspace access module 155 exemplified in FIG. 1.

The invitation code generation module 957 is connected to the authorization level vote module 950 and the invitation code delivery module 959. The invitation code generation module 957 generates an invitation code used for each existing member to invite a new member candidate. As will be described later, an invitation code is used as an input for computing authentication-authorization information, and an accurate value can be computed when all invitation codes are arranged. This achieves an effect that it is hard for a malicious third party to take information, and thus to prevent the malicious third party from causing spoofing by configuring authentication-authorization information.

The invitation code here is a hash value having information indicating an authorization level on which each existing member votes as an input. The “information indicating an authorization level” here is tagged text such as <authorization level> . . . </authorization level> shown in the data example described in the example of the first exemplary embodiment.

The invitation code delivery module 959 is connected to the invitation code generation module 957, the authorization level determination module 915 of the information processing apparatus 900, and an invitation code reception module 987 of the new member candidate user terminal 980. The invitation code delivery module 959 has a function of delivering an invitation code from each existing member to a new member candidate. As described above, the authorization level determination module 915 gives an instruction for delivery. During delivery of an invitation code, the invitation code including header information indicating an existing member from which the invitation code is delivered is delivered.

The member introducing person user terminal 960 includes the new member candidate information providing module 965, the authorization level vote module 970, the workspace access module 975, the invitation code generation module 977, and the invitation code delivery module 979. The member introducing person user terminal 960 is an information terminal which is able to perform communication with the information processing apparatus 900, and is used by an existing member of the workspace as an introducing person of a new member candidate.

The new member candidate information providing module 965 is connected to the invitation code delivery module 979, and the authentication-authorization module 930 of the information processing apparatus 900. The new member candidate information providing module 965 has a function equivalent to the function of the new member candidate information providing module 165 exemplified in FIG. 1.

The authorization level vote module 970 is connected to the invitation code generation module 977, and the authentication-authorization module 930 of the information processing apparatus 900. The authorization level vote module 970 has a function equivalent to the function of the authorization level vote module 170 exemplified in FIG. 1.

The workspace access module 975 is connected to the authentication-authorization module 930 of the information processing apparatus 900. The workspace access module 975 has a function equivalent to the function of the workspace access module 175 exemplified in FIG. 1.

The invitation code generation module 977 is connected to the authorization level vote module 970 and the invitation code delivery module 979. The invitation code generation module 977 generates an invitation code used for each existing member to invite a new member candidate. As will be described later, an invitation code is used as an input for computing authentication-authorization information, and an accurate value can be computed when all invitation codes are arranged. This achieves an effect that it is hard for a malicious third party to take information, and thus to prevent the malicious third party from causing spoofing by configuring authentication-authorization information.

The invitation code here is a hash value having information indicating an authorization level on which each existing member votes as an input. The “information indicating an authorization level” here is tagged text such as <authorization level> . . . </authorization level> shown in the data example described in the example of the first exemplary embodiment.

The invitation code delivery module 979 is connected to the new member candidate information providing module 965, the invitation code generation module 977, the authorization level determination module 915 of the information processing apparatus 900, and the invitation code reception module 987 of the new member candidate user terminal 980. The invitation code delivery module 979 has a function of delivering an invitation code from each existing member to a new member candidate. As described above, the authorization level determination module 915 gives an instruction for delivery. During delivery of an invitation code, the invitation code including header information indicating an existing member from which the invitation code is delivered is delivered.

The new member candidate user terminal 980 includes the authentication-authorization information tool reception module 985, the invitation code reception module 987, the invitation code incorporation module 989, and the workspace access module 990. The new member candidate user terminal 980 is an information terminal which is able to perform communication with the information processing apparatus 900, and is used by a new member candidate who is not a member of the workspace.

The authentication-authorization information tool reception module 985 is connected to an invitation code incorporation module 989, and the authentication-authorization information tool delivery module 925 of the information processing apparatus 900. The authentication-authorization information tool reception module 985 has a function equivalent to the function of the authentication-authorization information reception module 185 exemplified in FIG. 1. The authentication-authorization information tool reception module 985 has a function of receiving and preserving a tool delivered to the new member candidate user terminal 980.

The invitation code reception module 987 is connected to the invitation code incorporation module 989, the invitation code delivery module 959 of the existing member user terminal 940, and the invitation code delivery module 979 of the member introducing person user terminal 960. The invitation code reception module 987 has a function of receiving and preserving an invitation code delivered to a new member candidate (a user of the new member candidate user terminal 980) from each existing member (a user of the existing member user terminal 940 (specifically, the invitation code delivery module 959) and a user of the member introducing person user terminal 960 (specifically, the invitation code delivery module 979)).

The invitation code incorporation module 989 is connected to the authentication-authorization information tool reception module 985, the invitation code reception module 987, and the workspace access module 990. The invitation code incorporation module 989 has a function of incorporating the invitation code preserved in the invitation code reception module 987 into the tool preserved in the authentication-authorization information tool reception module 985 according to a formula recorded in the tool. Consequently, authentication-authorization information can be assembled in a client of the new member candidate.

The workspace access module 990 is connected to the invitation code incorporation module 989, and the authentication-authorization module 930 of the information processing apparatus 900. The workspace access module 990 has a function equivalent to the function of the workspace access module 190 exemplified in FIG. 1.

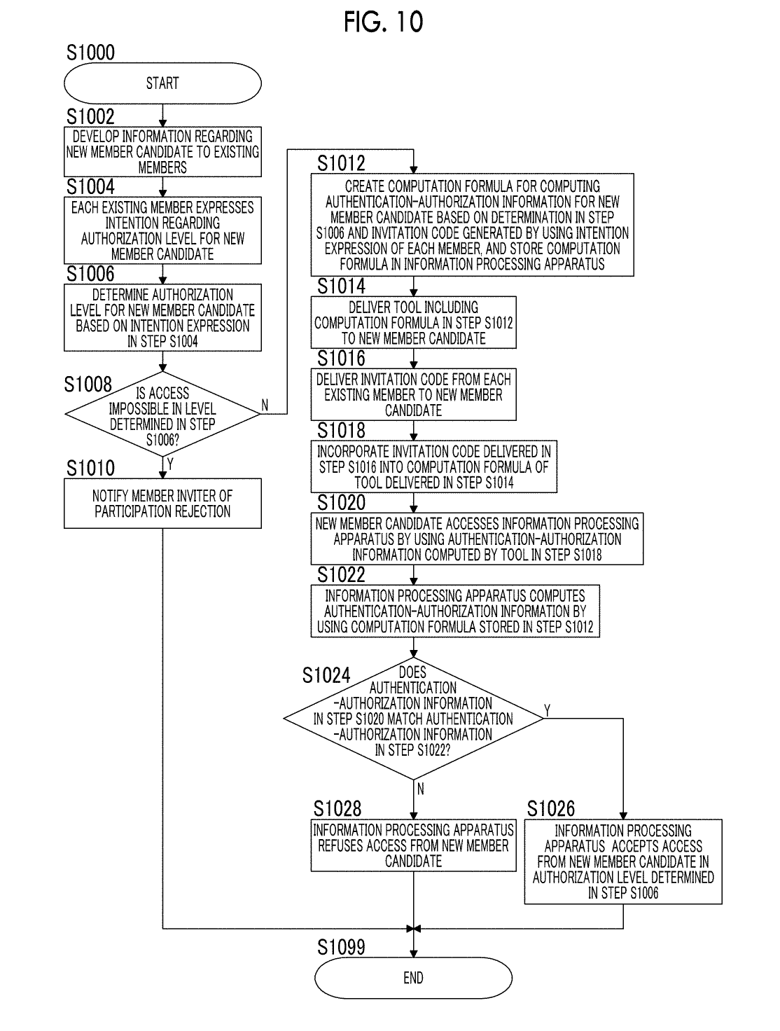

FIG. 10 is a flowchart illustrating a process example according to the second exemplary embodiment. Processes in step S1002 to step S1010, step S1026, and step S1028 are equivalent to the processes in step S302 to step S310, step S320, and step S322 in the flowchart illustrated in the example in FIG. 3.

In step S1002, information regarding a new member candidate is developed to an existing member.

In step S1004, each existing member expresses intention for an authorization level for the new member candidate.

In step S1006, an authorization level for the new member candidate is determined on the basis of the intention expression in step S1004.

In step S1008, it is determined whether or not access is impossible in the level determined in step S1006, and, in a case where access is impossible, the flow proceeds to step S1010, and, in other cases, the flow proceeds to step S1012.

In step S1010, a member inviter is notified of a participation rejection, and the process is finished (step S1099).

In step S1012, a computation formula (a principal portion of a tool) for computing authentication-authorization information for the new member candidate on the basis of the determination in step S1006 and an invitation code generated by using the intention expression of each member, and is stored in the information processing apparatus 900.

In step S1014, the tool including the computation formula in step S1012 is delivered to the new member candidate.

In step S1016, the invitation code is delivered from each existing member to the new member candidate.

In step S1018, the invitation code delivered in step S1016 is incorporated into the computation formula of the tool delivered in step S1014.

In step S1020, the information processing apparatus 900 is accessed according to an operation of the new member candidate by using authentication-authorization information computed by the tool in step S1018.

In step S1022, the information processing apparatus 900 computes authentication-authorization information by using the computation formula stored in step S1012.

In step S1024, it is determined whether or not the authentication-authorization information in step S1020 matches the authentication-authorization information in step S1022, and, in a case where both pieces of the authentication-authorization information match each other, the flow proceeds to step S1026, and, in other cases, the flow proceeds to step S1028.

In step S1026, the information processing apparatus 900 accepts access from the new member candidate in the authorization level determined in step S1006.

In step S1028, the information processing apparatus 900 refuses access from the new member candidate.

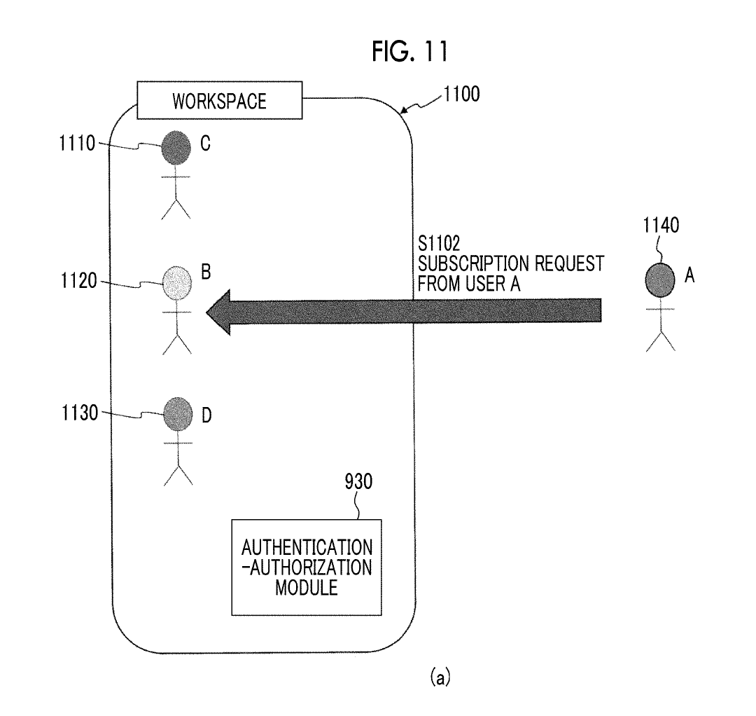

FIGS. 11 to 19 are diagrams illustrating process examples ((a) to (i)) according to the second exemplary embodiment.

FIG. 11 is a diagram illustrating a process example according to the second exemplary embodiment.

A user C: 1110, a user B: 1120, and a user D: 1130 are registered in a workspace 1100 as existing members. There is a user A: 1140 who is not a member of the workspace 1100. In descriptions of FIGS. 11 to 19, for better understanding of the descriptions, it will be described that the user C: 1110 or the like performs a process, but each of the existing member user terminals 940 used by the user C: 1110 and the user D: 1130, the member introducing person user terminal 960 used by the user B: 1120, and the new member candidate user terminal 980 used by the user A: 1140 performs the process.

In step S1102, the user B: 1120 receives a subscription request from the user A: 1140.

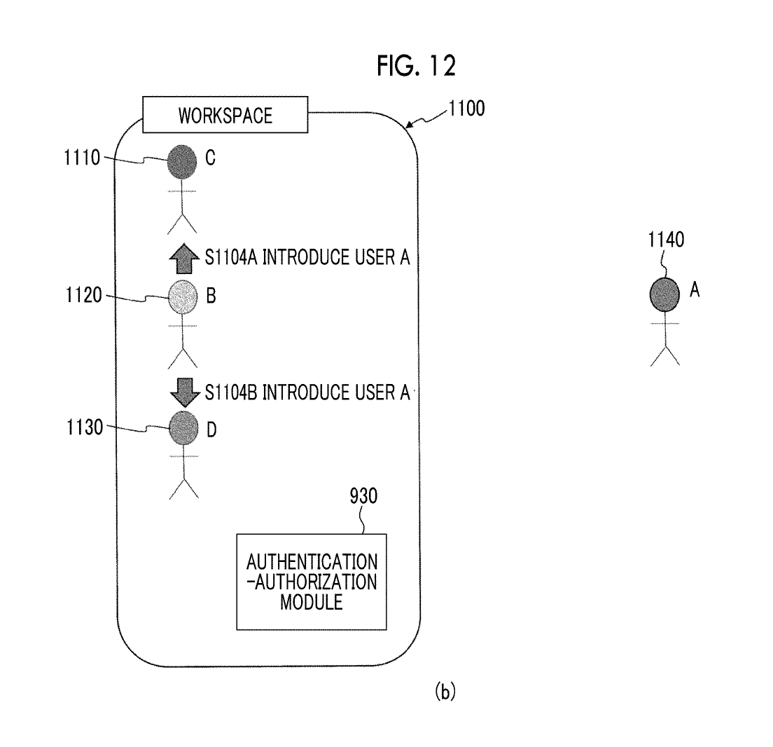

FIG. 12 is a diagram illustrating a process example according to the second exemplary embodiment.

In step S1104A, the user B: 1120 introduces the user A: 1140 to the user C: 1110 via the information processing apparatus 900.

In step S1104B, the user B: 1120 introduces the user A: 1140 to the user D: 1130 via the information processing apparatus 900.

Step S1104 (step S1104A and step S1104B) is a process corresponding to step S1002.

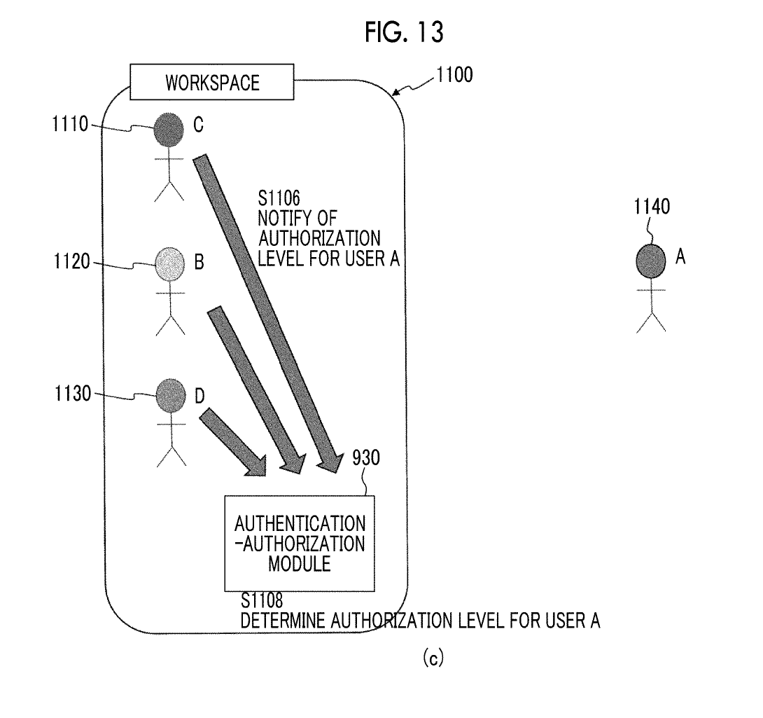

FIG. 13 is a diagram illustrating a process example according to the second exemplary embodiment.

In step S1106, the user C: 1110, the user B: 1120, and the user D: 1130 notifies the authentication-authorization module 930 of an authorization level for the user A: 1140.

Step S1106 is a process corresponding to step S1004.

In step S1108, the authentication-authorization module 930 determines an authorization level for the user A: 1140.

Step S1108 is a process corresponding to step S1006.

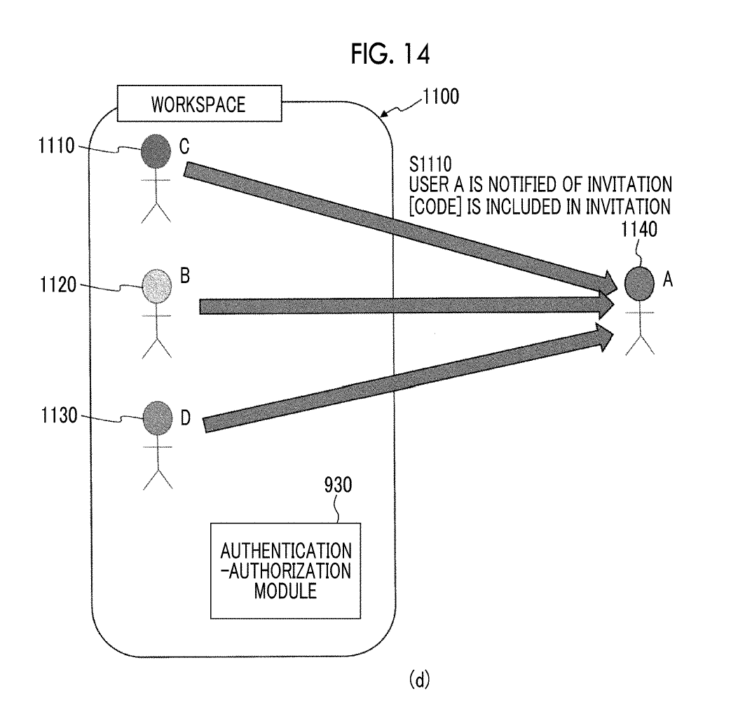

FIG. 14 is a diagram illustrating a process example according to the second exemplary embodiment.

In step S1110, the user C: 1110, the user B: 1120, and the user D: 1130 notifies the user A: 1140 of invitation. The invitation here includes an “invitation code”.

Step S1110 is a process corresponding to step S1016.

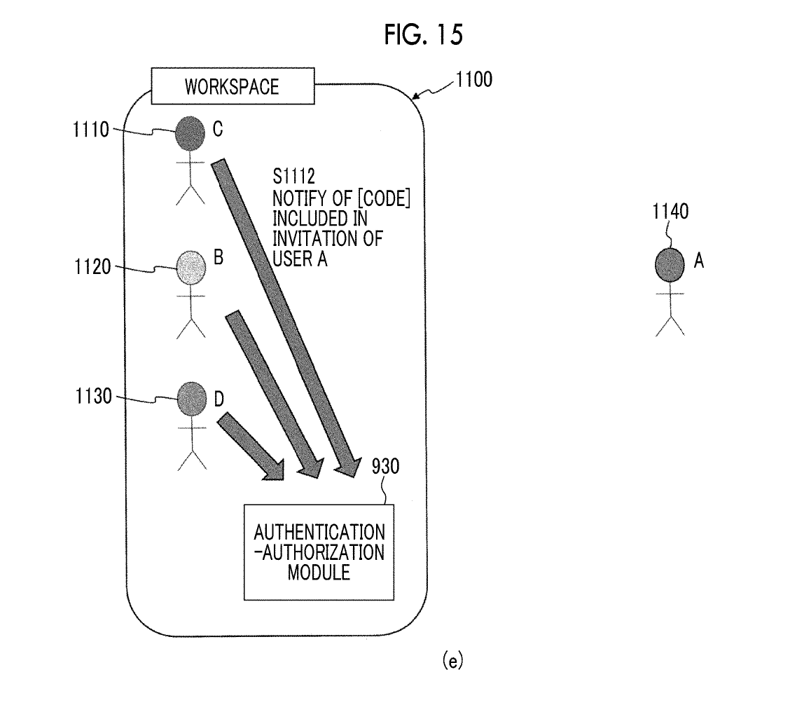

FIG. 15 is a diagram illustrating a process example according to the second exemplary embodiment.

In step S1112, the user C: 1110, the user B: 1120, and the user D: 1130 notifies the authentication-authorization module 930 of the “invitation code” included in the invitation of the user A: 1140. The authentication-authorization module 930 performs a process corresponding to step S1012. The process in step S1012 may be performed after the process in step S1016.

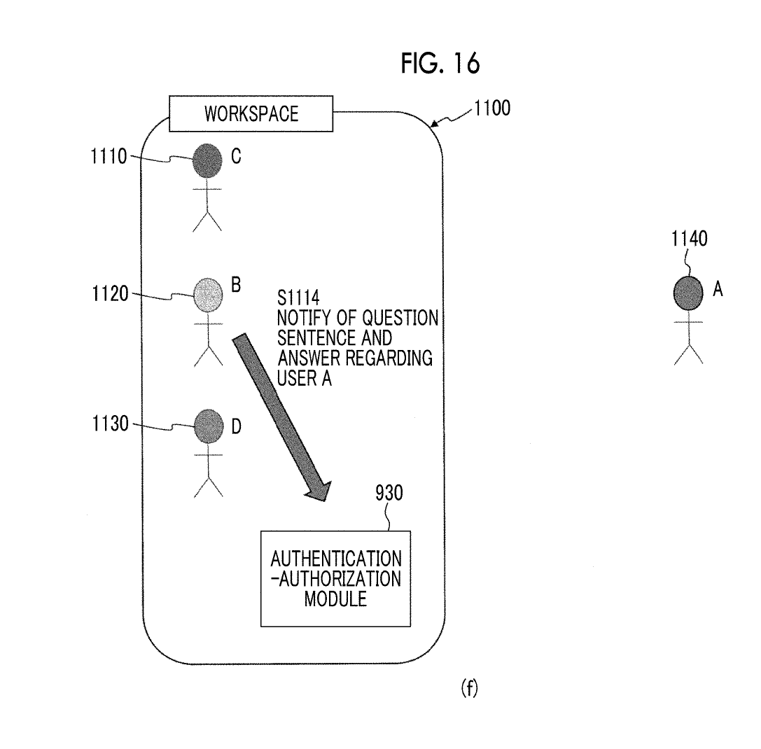

FIG. 16 is a diagram illustrating a process example according to the second exemplary embodiment.

In step S1114, the user B: 1120 notifies the authentication-authorization module 930 of a question sentence and an answer regarding the user A: 1140. This process is omitted in the flowchart illustrated in the example in FIG. 10, but is a new process for specifying the user A: 1140. The question sentence and the answer is a combination of a question sentence and an answer known to the user B: 1120 and the user A: 1140. In other words, the user A: 1140 is scheduled to return a predetermined answer to the question sentence.

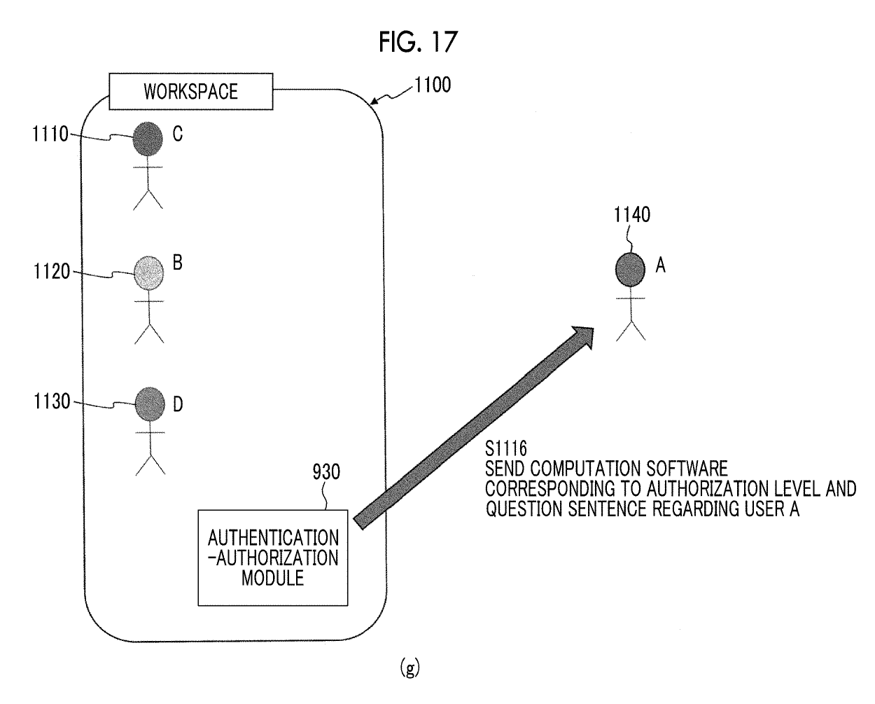

FIG. 17 is a diagram illustrating a process example according to the second exemplary embodiment.

In step S1116, the authentication-authorization module 930 sends computation software (an example of a tool) corresponding to the authorization level and the question sentence regarding the user A: 1140 to the user A: 1140.

Step S1116 is a process corresponding to step S1014. However, herein, the authentication-authorization module 930 also sends the question sentence regarding the user A: 1140 to the user A: 1140.

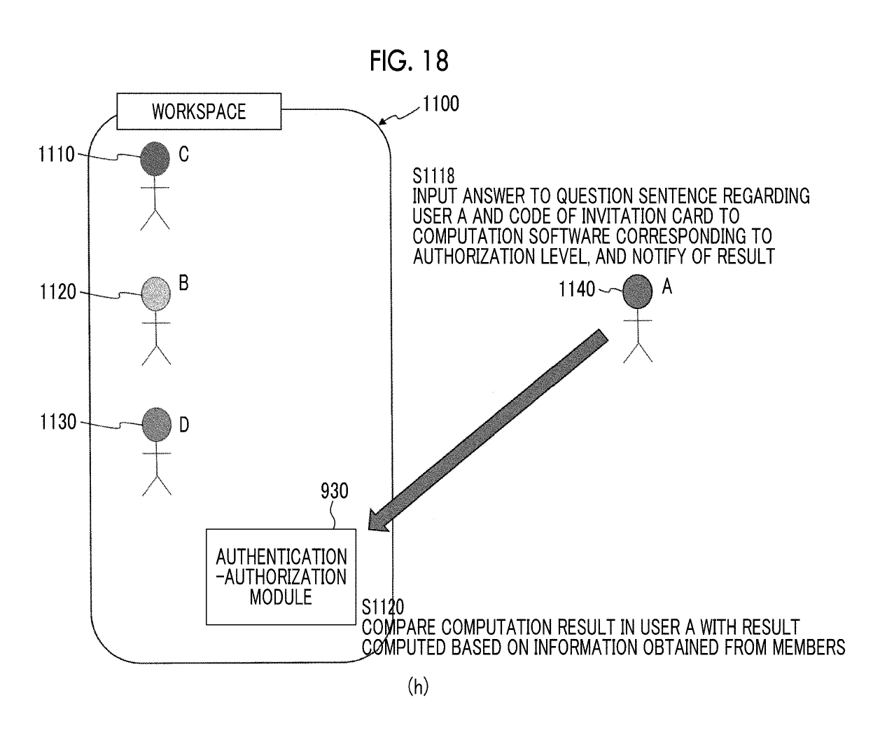

FIG. 18 is a diagram illustrating a process example according to the second exemplary embodiment.

In step S1118, the user A: 1140 inputs the answer to the question sentence regarding the user A: 1140 and a code of an invitation card to the computation software corresponding to the authorization level, and notifies the authentication-authorization module 930 of a computation result in the computation software.

Step S1118 is a process corresponding to step S1018 and step S1020. Herein, computation including the answer to the question sentence is performed. In other words, computation using the answer to the question sentence in the same manner as an invitation code is performed.

In step S1120, the authentication-authorization module 930 compares a computation result in the user A: 1140 with a result computed on the basis of information obtained from members (the user C: 1110, the user B: 1120, and the user D: 1130).

Step S1120 is a process corresponding to step S1022 and step S1024.

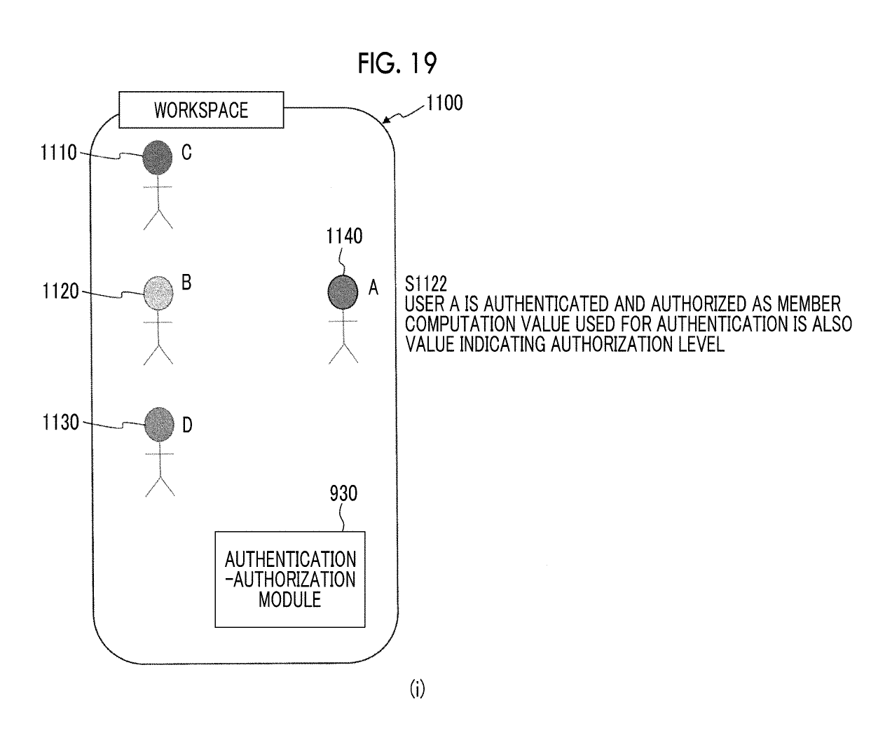

FIG. 19 is a diagram illustrating a process example according to the second exemplary embodiment.

In step S1122, in a case where it is determined that the results match each other as a comparison result in step S1120, the user A: 1140 is authenticated and authorized as a member of the workspace 1100. A computation value used for authentication is also a value indicating an authorization level.

Step S1122 is a process corresponding to step S1026.

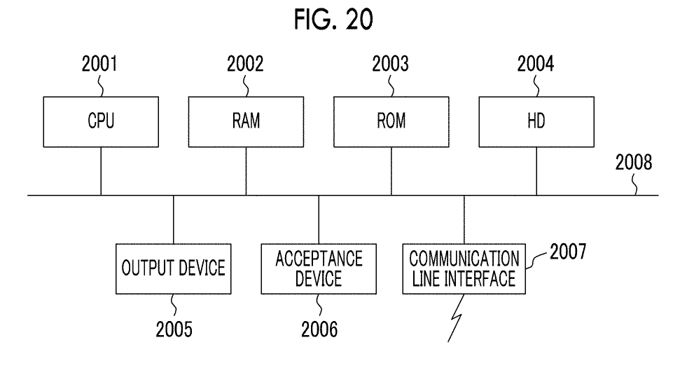

A hardware configuration of a computer executing a program as the present exemplary embodiment (the information processing apparatus 100 (900), the existing member user terminal 140 (940), the member introducing person user terminal 160 (960), and the new member candidate user terminal 180 (980)) is a hardware configuration of a general computer as exemplified in FIG. 20, and the computer is, specifically, a personal computer or a computer serving as a server. In other words, as a specific example, a CPU 2001 is used as a processing unit (calculation unit), and a RAM 2002, a ROM 2003, and an HD 2004 are used as a storage device. For example, a hard disk or a solid state drive (SSD) may be used as the HD 2004. The computer includes the CPU 2001 executing programs such as the authorization level determination module 115, the authentication-authorization information computation module 120, the authentication-authorization information delivery module 125, the authentication-authorization module 130, the new member candidate information checking module 145, the authorization level vote module 150, the workspace access module 155, the new member candidate information providing module 165, the authorization level vote module 170, the workspace access module 175, the authentication-authorization information reception module 185, the workspace access module 190, the authorization level determination module 915, the authentication-authorization information tool creation module 920, the authentication-authorization information tool delivery module 925, the invitation code generation module 927, the authentication-authorization module 930, the new member candidate information checking module 945, the authorization level vote module 950, the workspace access module 955, the invitation code generation module 957, the invitation code delivery module 959, the new member candidate information providing module 965, the authorization level vote module 970, the workspace access module 975, the invitation code generation module 977, the invitation code delivery module 979, the authentication-authorization information tool reception module 985, the invitation code reception module 987, the invitation code incorporation module 989, and the workspace access module 990; the RAM 2002 storing the programs or data; the ROM 2003 storing a program or the like for activating the computer; the HD 2004 which is an auxiliary storage device (which may be a flash memory or the like) functioning as the workspace information preservation module 105, the new member candidate information preservation module 110, the workspace information preservation module 905, and the new member candidate information preservation module 910; an acceptance device 2006 which accepts data on the basis of a user's operation (including an action, a voice, a visual line, and the like) on a keyboard, a mouse, a touch screen, a microphone, or a camera (including a visual line detection camera or the like); an output device 2005 such as a CRT, a liquid crystal display, or a speaker; a communication line interface 2007 for connection to a communication network such as a network interface card; and a bus 2008 connecting the above-described elements to each other for exchanging data. Such a plurality of computers may be connected to each other via a network.

Among the above-described exemplary embodiments, in a case of the exemplary embodiment based on a computer program, the computer program which is software is read to a system having the present hardware configuration, and the exemplary embodiment is realized through cooperation between the software and the hardware resources.

The hardware configuration illustrated in FIG. 20 corresponds to one configuration example, and the present exemplary embodiment is not limited to the configuration illustrated in FIG. 20, and any configuration in which the modules described in the present exemplary embodiment can be executed may be used. For example, some of the modules may be configured with dedicated hardware (for example, an application specific integrated circuit (ASIC)), some of the modules may be provided in an external system, and may be connected to a communication line, and such a plurality of systems illustrated in FIG. 20 may be connected to each other via a communication line so as to operate in cooperation therebetween. Particularly, the modules may be incorporated not only into a personal computer but also into a portable information communication apparatus (including a mobile phone, a smart phone, a mobile apparatus, a wearable computer, and the like), an information appliance, a robot, a copier, a facsimile, a scanner, a printer, a multi-function peripheral (an image processing apparatus having two or more functions of a scanner, a printer, copier, and a facsimile).

The program may be stored on a recording medium so as to be provided, and the program may be provided by using a communication unit. In this case, for example, the program may be understood as the invention of a “non-transitory computer readable medium storing the program”.

The “non-transitory computer readable medium storing the program” indicates a computer readable recording medium storing the program, used to install, execute, and distribute the program.

The recording medium includes, for example, “a DVD-R, a DVD-RW, a DVD-RAM, or the like” which is a digital versatile disc (DVD) and is a standard defined in the DVD forum, and “a DVD+R, DVD+RW, or the like” which is a standard defined in the DVD+RW, a compact disc (CD) read only memory (CD-ROM), a CD recordable (CD-R), or a CD rewritable (CD-RW), a Blu-ray (registered trademark) disc, a magnetooptical disc (MO), a flexible disk (FD), a magnetic tape, a hard disk, a read only memory (ROM), an electrically erasable programmable read only memory (EEPROM) (registered trademark), a flash memory, a random access memory (RAM), and a secure digital (SD) memory card.

The whole or a part of the program may be recorded on the recording medium so as to be preserved or distributed. The program may be transmitted through communication, for example, by using a transmission medium such as a wired network used for a local area network (LAN), a metropolitan area network (MAN), a wide area network (WAN), the Internet, an intranet, or an extranet, a wireless communication network, or a combination thereof, and may be carried via a carrier wave mounted therewith.

The program may be a part or the whole of another program, or may be recorded on a recording medium along with a separate program. The program may be divided and recorded on a plurality of recording media. The program may be recorded in any restorable aspect such as compression or encryption.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a disclosure unit that discloses information regarding a member candidate who wants to subscribe to a group of a plurality of persons as a new member, to existing members;
an acceptance unit that accepts authorizable authority for the member candidate from the existing members viewing the disclosed information; and
a determination unit that determines authority to be assigned to the member candidate according to the authorizable authority,
wherein the authority determined by the determination unit indicates authority of an operation in the group.

2. The information processing apparatus according to claim 1,
wherein the determination unit determines the authority by further using the information disclosed by the disclosure unit.

3. The information processing apparatus according to claim 2,
wherein the determination unit determines that predefined authority is not assigned in a case where a predefined item is not disclosed.

4. The information processing apparatus according to claim 1,
wherein the authority determined by the determination unit includes authority to access past information in the group.

5. The information processing apparatus according to claim 1,
wherein the determination unit determines the authority through statistical processing on the authorizable authority.

6. The information processing apparatus according to claim 5,
wherein the statistical processing includes one or more of decision by majority, a weight according to an existing member, or a logical operation.

7. The information processing apparatus according to claim 1, further comprising:
a generation unit that generates identification information for unique identification by using the authority determined by the determination unit;
a transmission unit that transmits the generated identification information to the member candidate;
a reception unit that receives information from the member candidate; and
an authorization unit that authorizes the member candidate as a member of the group in a case where the identification information matches the information received by the reception unit.

8. The information processing apparatus according to claim 7, further comprising:
a permission unit that permits the member candidate the authority determined by the determination unit in a case where the authorization unit authorizes the member candidate.

9. The information processing apparatus according to claim 7,
wherein the authorization unit authorizes the member candidate on the condition that invitation card information transmitted from the existing members is included in the information received by the reception unit.

10. A non-transitory computer readable medium storing an information processing program causing a computer to function as:
a disclosure unit that discloses information regarding a member candidate who wants to subscribe to a group of a plurality of persons as a new member, to existing members;
an acceptance unit that accepts authorizable authority for the member candidate from the existing members viewing the disclosed information; and
a determination unit that determines authority to be assigned to the member candidate according to the authorizable authority,
wherein the authority determined by the determination unit indicates authority of an operation in the group.

11. An information processing apparatus comprising:
disclosure means for disclosing information regarding a member candidate who wants to subscribe to a group of a plurality of persons as a new member, to existing members;
acceptance means for accepting authorizable authority for the member candidate from the existing members viewing the disclosed information; and
determination means for determining authority to be assigned to the member candidate according to the authorizable authority,
wherein the authority determined by the determination means indicates authority of an operation in the group.
